(19) United States
(12) Patent Application Publication
(10) Pub. No.: US 2009/0045106 A1
(43) Pub. Date: Feb. 19, 2009

(54) WATER TREATMENT SYSTEM

(75) Inventors: Roy W. Kuennen, Caledonia, MI (US); Kenneth E. Conrad, Ada, MI (US); Roy M. Taylor, JR., Rockford, MI (US)

Correspondence Address: WARNER, NORCROSS & JUDD;IN RE: ALTICOR INC., INTELLECTUAL PROPERTY GROUP, 111 LYON STREET, N. W. STE 900, GRAND RAPIDS, MI, 49503-2489, US

(73) Assignee: ACCESS BUSINESS GROUP INTERNATIONAL LLC, Ada, MI (US)

(21) Appl. No.: 12/192,342

(22) Filed: Aug. 15, 2008

Related U.S. Application Data
(60) Provisional application No. 60/955,937, filed on Aug. 15, 2007.

(51) Int. Cl. C02F 9/14; B01D 35/30; B01D 35/14

(52) U.S. Cl. 210/89; 210/259; 210/256; 210/232; 210/260; 210/88

(57) ABSTRACT

A water treatment system (“WTS”) includes a prefilter, a carbon block filter and a microbiological interception (“MI”) filter that operate in combination to treat a fluid stream, such as water. The WTS may include two prefilters, for example, both a multi-layer nonwoven prefilter and a pleated fabric prefilter. The MI filter may include carbon particles and a binder, and the carbon particles may have a mean particle diameter ranging from about 60 microns to about 80 microns and with a particle size distribution in which no more than about 10% by weight of the particles are larger than about 140 mesh and no more than about 10% by weight are smaller than about 500 mesh. In one embodiment, the water treatment system further includes a volumetric end-of-life filter monitor that monitors the life of the MI filter.

### BACKGROUND OF THE INVENTION

The present invention relates to water treatment systems and more particularly to point-of-use water treatment systems.

A variety of filter technologies have been developed for treating fluid streams, such as water intended for human consumption. For example, activate carbon filters have long been used to remove particulate and organic contaminants from water and other fluid streams. It is not uncommon for a water treatment system (“WTS”) to combine a carbon block filter with a source of radiant energy, such as an ultraviolet (“UV”) light source, to kill microorganisms in the filtered water. One such WTS is disclosed in U.S. Pat. No. 5,698,091 to Kuennen et al, which is incorporated herein by reference in its entirety. UV treatment devices typically include a UV bulb and associated ballast circuitry that add cost and complexity to the WTS.

Microbiological interception (“MI”) filters have been developed to reduce/trap/inactivate microorganisms in a fluid stream. For example, various MI filter-related technologies have been developed by Koslow Technologies Corp. and are disclosed in U.S. Pat. Nos. 6,835,311; 6,660,172; 6,872,311; 7,144,533; 6,953,604; 6,998,058; 7,008,537; 6,959,820; 7,011,752; 6,913,154; 6,866,704; 6,630,016; 6,550,622 and 6,770,204 (collectively, “the Koslow patents”). MI filters are typically less expensive than UV treatment devices because they are not electrically powered and do not require complex electrical circuitry. In general, MI filters have an inherent fail-safe mechanism that helps to protect the end user from consumption of water and other fluids treated after the MI filter has exceeded its operating life. More specifically, the flow rate of a typical MI filter will decrease over time in correspondence with the operating life of the MI filter. In other words, a conventional MI filter is designed so that its flow rate will continually decrease to a point where it essentially prevents use of the filter beyond its effective life. For example, conventional MI filters clog as a result of natural organic matter in the fluid stream. As organic matter accumulates within the microporous structure of the MI filter, the overall flow rate of the filter is decreased. Although this inherent clogging provides certain benefits, it also causes the MI filter to undergo increasingly lower flow rates, which causes the system to treat fluid more slowly and is undesirable in most applications. MI filters have sometimes been used with simple filter life monitors. For example, one known WTS with MI filter technology uses a filter life monitor that operates based on the “on time” of the system. This type of system records the amount of time that the system has been operated after the installation of a new MI filter, and signals for the replacement of the filter after a predetermined time period. This type of filter life monitor can provide a significantly inaccurate estimate of filter life when the pressure of the raw fluid varies. For example, when water pressure exceeds the expected pressure, the flow rate will increase and the filter life monitor will underestimate its usage. On the other hand, when water pressure is below the expected pressure the flow rate will decrease and the filter life monitor will overestimate its usage. Further, the MI filter is susceptible to premature clogging when the total organic carbon (“TOC”) present in the raw fluid is relatively high. For example, testing of a commercially available WTS with MI filter has shown that a MI filter rated for 2,000 gallons or six months may clog in as little as 50 gallons when subject to influent having a TOC level of as low as two parts per million.

### SUMMARY OF THE INVENTION

The present invention provides a water treatment system (“WTS”) having a prefilter, a carbon block filter and a microbiological interception (“MI”) filter that operate in combination to treat a fluid stream, such as water. In one embodiment, the prefilter is a multi-layer nonwoven prefilter. In another embodiment, the prefilter is a pleated fabric prefilter. If desired, the WTS may include two prefilters, for example, both a multi-layer nonwoven prefilter and a pleated fabric prefilter.

In one embodiment, the water treatment system further includes a volumetric end-of-life filter monitor that monitors the life of the MI filter. In this embodiment, the MI filter may be configured to provide at least a predetermined flow rate throughout its rated life.

In one embodiment, the MI filter may include carbon particles and a binder. The MI filter may include a carbon particle distribution that with a mean particle diameter ranging from about 60 microns to about 80 microns and with a particle size distribution in which no more than about 10% by weight of the particles are larger than about 140 mesh and no more than about 10% by weight are smaller than about 500 mesh.

These and other objects, advantages, and features of the invention will be readily understood and appreciated by reference to the detailed description of the current embodiment and the drawings.

### BRIEF DESCRIPTION OF THE DRAWINGS

FIG. 1A is a front perspective view of a WTS in accordance with an embodiment of the present invention.

FIG. 1B is a rear perspective view of the WTS.

FIG. 2 is an exploded perspective view of the WTS.

FIG. 3A is a perspective view of a filter assembly for one embodiment of the WTS with the pleated prefilter removed.

FIG. 3B is an exploded perspective view of the filter assembly.

FIGS. 4a-f are perspective views showing installation of the pleated prefilter on the filter assembly.

### DESCRIPTION OF THE CURRENT EMBODIMENT

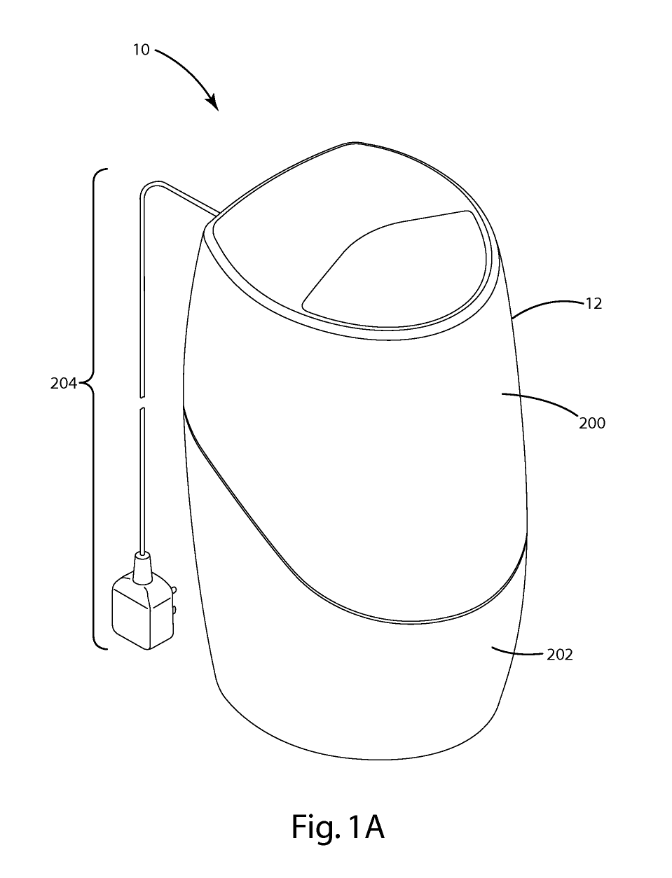

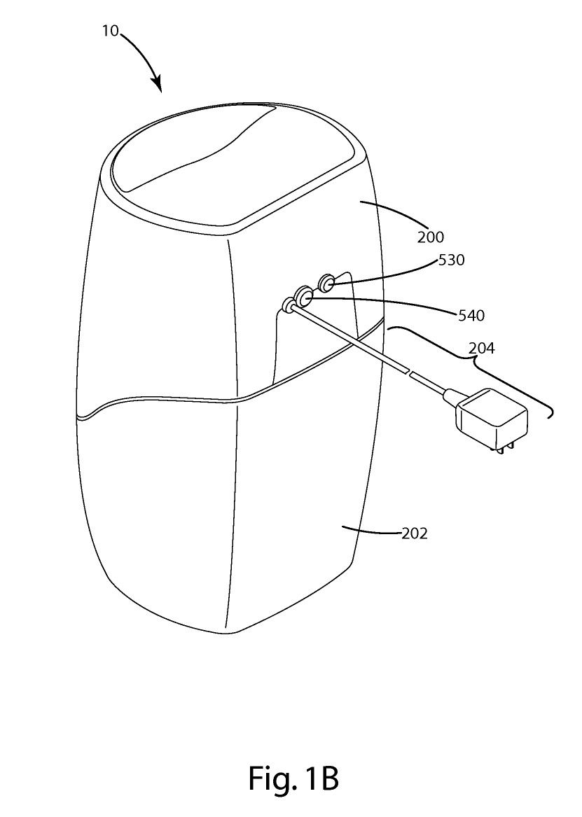

A water treatment system (“WTS”) according to an embodiment of the present invention is shown in FIG. 1 and generally designated by the reference numeral 10. The WTS 10 generally includes a main housing 12 and a filter assembly 14. The filter assembly 14 of the illustrated embodiment includes a microbiological interception (“MI”) filter 16, a carbon block filter 18, a nonwoven prefilter 20 and a pleated fabric prefilter 22. The WTS 10 also includes a flow path for directing fluid, such as water, through the filter assembly 14. Except as otherwise described herein, the WTS of the present invention may be generally identical to the WTS shown in U.S. Pat. No. 6,984,320 to Bartkus et al, which is incorporated herein by reference in its entirety. Although described in connection with a WTS that generally conforms with the WTS shown in the Bartkus et al patent, the present invention is well-suited for use in essentially any WTS design or configuration.

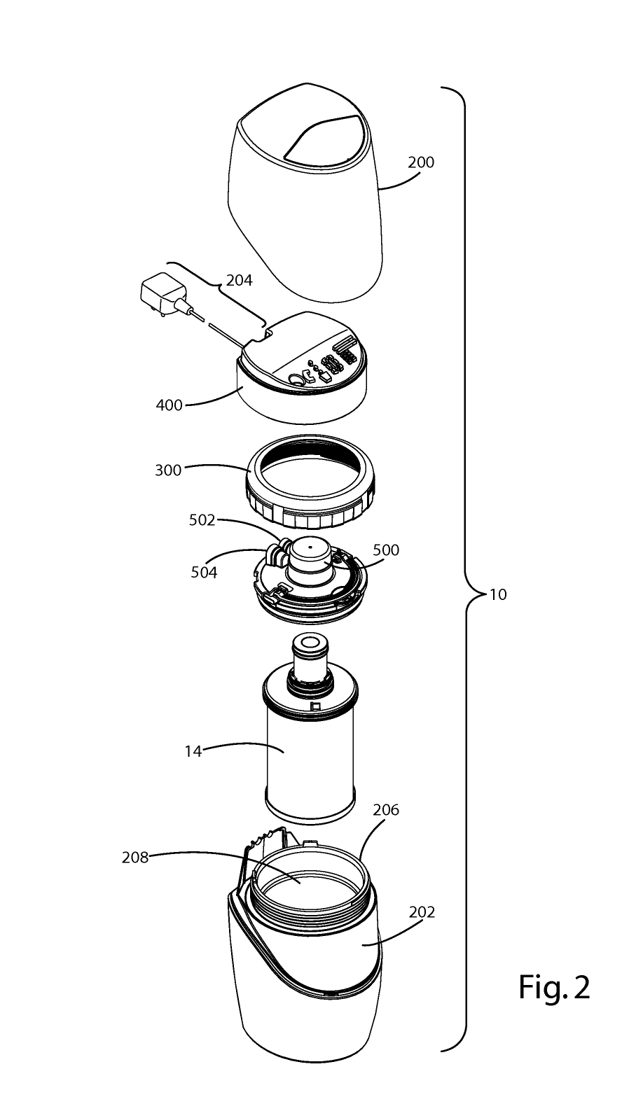

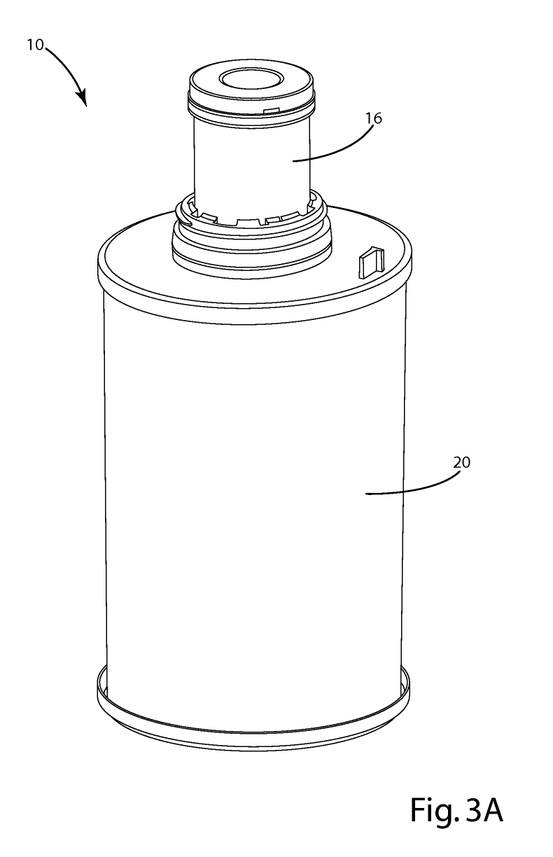

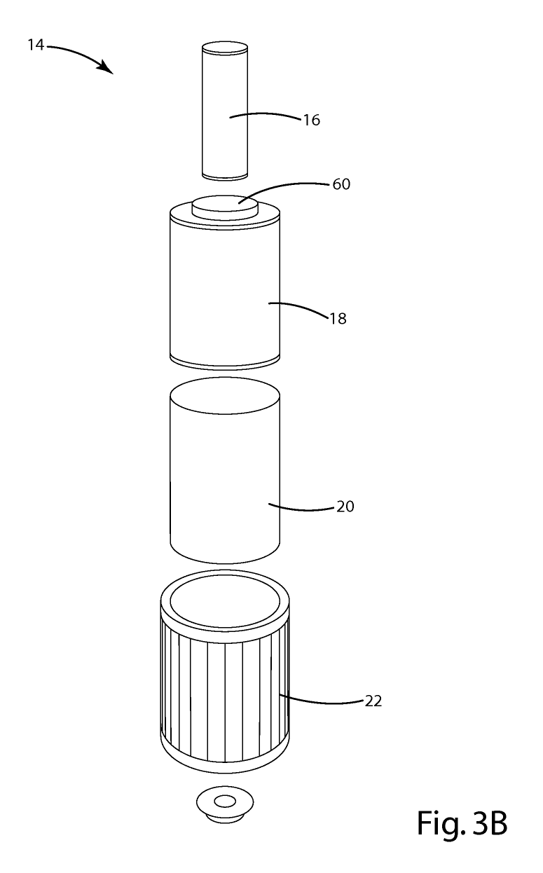

FIGS. 1A and 1B provide two perspective views of a typical WTS 10 that incorporates the present invention. WTS 10 includes top shroud 200, base housing 202, power supply cord 204, treated water outlet 530 and raw water inlet 540. Major subcomponents of WTS 10 are shown in exploded view in FIG. 2. These subcomponents include top shroud 200, a base housing 202, filter assembly 14, retaining ring 300, electronics module 400 with attached power supply cord 204, and filter bracket 500. Referring to FIG. 3, base housing 202 includes threaded surface 206 which removably attaches to retaining ring 300. Threaded surface 206 may be threaded or otherwise adapted to allow the removable attachment of retaining ring 300. Base housing 202 is further comprised of cylindrical fluid treatment chamber 208, which houses filter assembly 14 during operation of WTS 10. The walls of cylindrical fluid treatment chamber 208 sealingly cooperate with filter bracket 500 to form a closed pressure vessel in which water is passed through filter assembly 14 as discussed in more detail below. Although WTS 10 is illustrated as including a power cord 204, it should be noted that, alternatively, WTS 10 could be powered with a conventional battery source (not shown), such as a conventional battery positioned in the top shroud 200 or base housing 202 proximate the electronics module 400. The battery may be accessible behind a removable or openable battery access door.

As noted above, the filter assembly 14 of the present invention includes multiple filters. The illustrated embodiment includes an arrangement of filters 16, 18, 20 and 22 that provide removal of particulate, VOC and microbiological contaminants. In the illustrated embodiment, the filters 16, 18, 20 and 22 are arranged in a coaxial configuration with the MI filter 16 located at the center, the carbon block filter 18 surrounding the MI filter 16, the nonwoven prefilter 20 wrapped about the carbon block filter 18 and the pleated fabric prefilter 22 disposed about the nonwoven prefilter 20. In this configuration, the fluid flows radially inwardly through the outermost filter (i.e. pleated fabric prefilter 22) and then sequentially radially inwardly through each successive filter (i.e. nonwoven prefilter 20 and carbon block filter 18) until it reaches and passes through the innermost filter (e.g. MI filter 16). The filters 16, 18, 20 and 22 may be arranged in other configurations, for example, by positioning the filters one adjacent to the next in a serial arrangement. The flow rate and capacity of the filter assembly (and the individual filters) may vary from application to application. However, in the illustrated embodiment, the filter assembly 14 may have a flow rate in the range of 0.7 to 0.9 gallons per minute with a capacity of 1,000 to 2,000 gallons with NSFI claims for Standard 53 VOC reduction. The dimensions of the filter assembly 14 and various filters may vary from application to application, but in the illustrated embodiment, the filter assembly 14 may be roughly 5″ in diameter and 7½″ long. The MI filter 16 may have an outer diameter of approximately 2.6″ and a length of approximately 6½″. The carbon block filter 18 may have an inner diameter of sufficient size to be fitted around the MI filter and have an outer diameter of approximately 4.2″.

The WTS 10 includes one or more filter housings to enclose the various filters and prefilters, and to provide a flow path for the raw fluid through the filters. The filter housing(s) may be easily opened and closed to facilitate filter maintenance, such as by retaining ring 300. As noted above, the WTS 10 of the illustrated embodiment includes a filter housing that is essentially identical to the filter housing of U.S. Pat. No. 6,984,320 to Bartkus et al. In the illustrated embodiment, the base housing 202, filter bracket 500 and retaining ring 300 cooperatively define and selectively close the filter chamber 208. More specifically, the filter bracket 500 is fitted over the open upper end of the base housing 202 to hold the filters within the filter chamber 208. The retaining ring 300 secures the filter bracket 500 to the base housing 202. The base housing 202 includes a threaded region 206 adjacent its open end to threadedly receive the retaining ring 300. The filter bracket 500 may include separate inlet and outlet ports 502 and 504 to allow untreated fluid to enter and treated fluid to exit the filter chamber 208. Flow control can be accomplished either by incorporation of a flexible orifice or limiting the size of the exit port on the system or one of the filters. The various components of the filter housing may be manufactured from a thermoplastic polymer, such as glass filled polypropylene, or metal. In this embodiment, the filter housing is a generally cylindrical housing with an open upper end, but its size, shape and configuration may vary from application to application. The use of a single housing, as shown in the illustrated embodiment, provides a number of advantages over multiple housing systems. For instance, the single housing system is simpler to manufacture and install, and reduces the size of the WTS.

Referring now to FIGS. 3A and 3B, in the illustrated embodiment, the filters (including prefilters) are combined into a single filter assembly 14 (or filter cartridge) that facilitates removal and replacement of all of the filters simultaneously. As a result, it is desirable (but not necessary) to design the various filters so that have roughly the same operating life. If desired, the pleated prefilter 22 may be separately removable and replaceable from the filter assembly 14. If desired, the various filters may be separately removable and replaceable. In applications that include separately removable filters, each filter may be independently secured to a filter bracket or other suitable components.

The MI filter 16 may be a conventional microbiological interception filter. For example, the MI filter 16 may be manufactured in accordance with the microbiological interception filter technology disclosed in one or more of the following patents issued to Koslow Technologies Corporation: U.S. Pat. Nos. 6,835,311; 6,660,172; 6,872,311; 7,144,533; 6,953,604; 6,998,058; 7,008,537; 6,959,820; 7,011,752; 6,913,154; 6,866,704; 6,630,016; 6,550,622 and 6,770,204 (collectively, “the Koslow patents”), all of which are incorporated herein by reference in their entirety. The MI filter 16 may include a microporous structure made of an array of active particles. The active particles may be joined by a binder. A microbiological interception enhancing agent is formed on the microporous structure. The microbiological interception enhancing agent may include cationic material in combination with a biologically active metal. Although the active particles of the microporous structure may be any of variety of active particles, such as any of the various active particles disclosed in the Koslow patents, the active particles in the illustrated embodiment are activated carbon particles. Similarly, the biologically active metal may be essentially any suitable biologically active metal, such as the biologically active metals disclosed in the Koslow patents, including, but not limited to, silver, copper, zinc, cadmium, mercury, antimony, gold, aluminum, platinum, palladium, and combinations thereof.

In the illustrated embodiment, the MI filter 16 is manufactured in accordance with the teachings of one or more of the Koslow patents, except that the MI filter 16 may be modified to overcome the tendency of the MI filter 16 to undergo significant flow rate reduction over its useful life. To this end, the MI filter 16 of the present invention may include an active particle distribution with a larger mean particle size than disclosed in the Koslow patents. In the illustrated embodiment, the active particles of the MI filter 16 are activated carbon particles having a mean particle size distribution that corresponds with the disclosure of U.S. Pat. No. 6,368,504 to Kuennen et al, which is incorporated herein by reference in its entirety. For example, in the illustrated embodiment, the MI filter 16 may include a carbon mixture in which the mean particle diameter ranges between approximately 60 microns and 80 microns, and in which the +140 mesh particles and the −500 mesh particles are each less than approximately 10% of the particle size distribution. The mean particle diameter is, however, more preferably about 65 to about 75 microns, and most preferably about 70 microns. The +140 mesh particles and the −500 mesh particles are more preferably each less than approximately 8% of the particle size distribution, and most preferably each less than approximately 7% and 7.5%, respectively, of the particle size distribution. In another effort to address the tendency of the MI filter 16 to undergo significant flow rate reduction over its useful life, the MI filter 16 may include a different cationic polymer than disclosed in the Koslow patents. In this embodiment, the cationic polymer may be selected to provide the desired charge density and selectivity of the media. For example, a cationic polymer with a smaller charge may result in less clogging and hence greater flow rates through the life of the MI filter 16.

The carbon block filter 18 may be a conventional carbon block filter, such as the carbon block water filter disclosed in U.S. Pat. No. 6,368,504 to Kuennen et al, which as noted above is incorporated herein by reference in its entirety. As shown in FIG. 3B, the carbon block filter 18 may be generally cylindrical and include a central, coaxial bore 60 of sufficient size and shape to receive the MI filter 16. If desired, the carbon block filter 18 may be replaced by other VOC filters or eliminated altogether in application where the additional VOC reduction is not necessary.

As noted above, the WTS 10 may include one or more prefilters. In the illustrated embodiment, shown in FIGS. 3A and 3B, the WTS includes two prefilters. A nonwoven prefilter material 20 may be wrapped about the carbon block filter 18 to filter particulate matter before it reaches the carbon block filter 18. The nonwoven prefilter 20 may be manufactured in accordance with the teachings of U.S. Pat. No. 6,368,504 to Kuennen et al. For example, in the illustrated embodiment, the nonwoven prefilter 20 includes a layer of nonwoven scrim (not shown) and a somewhat thicker layer of nonwoven fabric are cut and wrapped around the carbon block filter 18. The nonwoven fabric may have an effective porosity of about 10 microns and a thickness of approximately ⅛ of an inch. However, these specifications may vary from application to application. The fabric and scrim may be held in place by a plastic net that is wrapped around the outside of the fabric and scrim in a conventional manner.

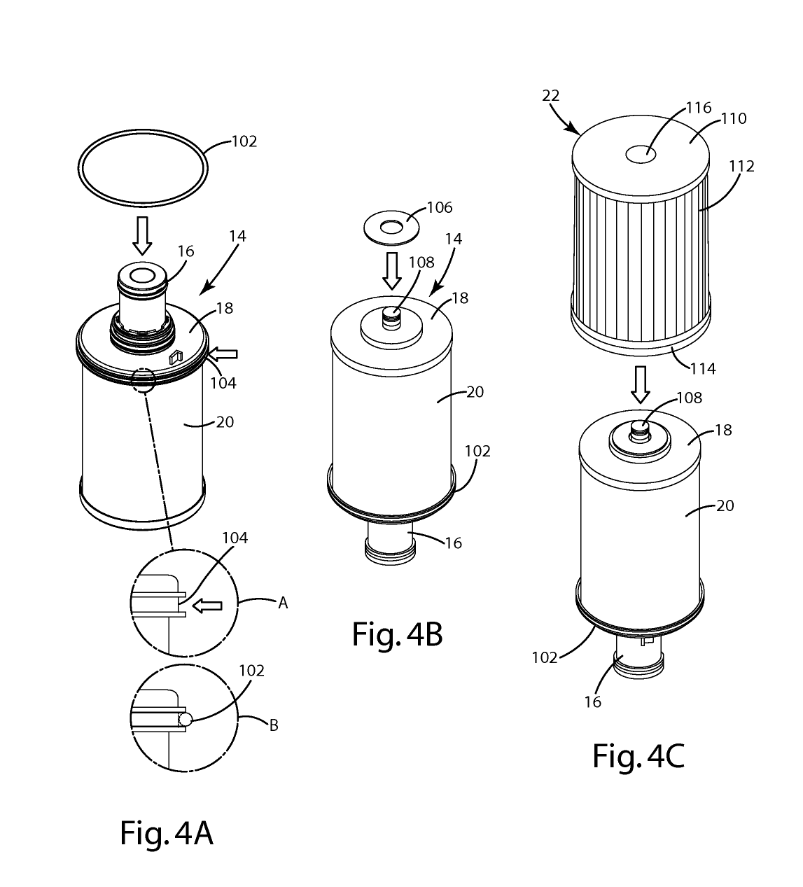

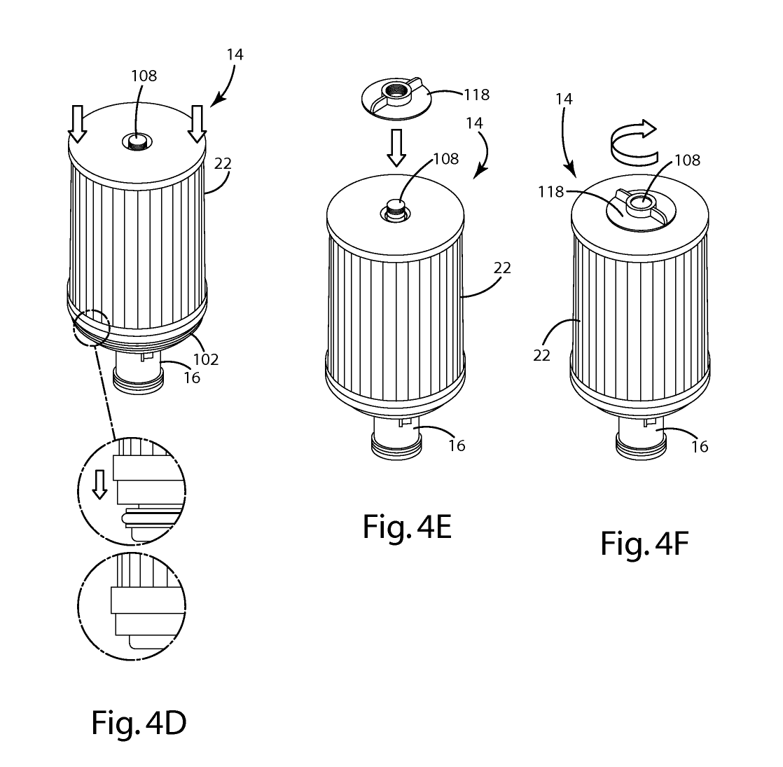

A pleated fabric prefilter 22 may be disposed coaxially about the carbon block filter 18. The pleated fabric prefilter 22 may be a nonwoven polypropylene, such as a melt blow polypropylene. As shown in FIG. 4c, the pleated fabric prefilter 22 of the illustrated embodiment generally includes a base plate 110, a pleated filter medium 112 and a cap ring 114. The base plate 110 defines a central mounting hole 116 adapted to be fitted over a mounting stud 108 on the base of the carbon block filter 18. The illustrated pleated fabric prefilter 22 includes an inner diameter that is at least slightly larger than the outer diameter of the carbon block filter 18 and nonwoven prefilter 20. The pleated fabric prefilter 22 may be integrated with the carbon block filter 18 so that the two filters are replaceable together or the prefilter 22 may be separable from the carbon block filter 18 so that it can be separately removed and replaced. FIGS. 4a-f include a series of drawings that illustrate the process of installing the pleated prefilter 22 on the filter assembly 14 in the illustrated embodiment. In general, the pleated prefilter 22 is fitted over the carbon block filter 18 and secured using a threaded retaining nut 118 that is secured to a threaded mounting stud 108. As shown in FIG. 4a, the filter assembly 14 includes a gasket 102 and a gasket seat 104 (see enlarged inset A) to seal one end of the pleated prefilter 22. The gasket 102 is fitted within the gasket seat 104 (see enlarged inset B). As shown in FIG. 4b, a seal 106 is next fitted over the prefilter mounting stud 108. The pleated prefilter 22 is then fitted over the filter assembly 14 with the mounting hole 116 fitted over the mounting stud 108 and the base plate 110 engaging the seal 106. This action causes the pleated prefilter 22 to be forced down over the carbon block filter 18 until the cap ring 114 is engaged with the gasket 102 to seal the free end of the pleated prefilter 22. The retaining nut 118 is then installed on the mounting stud 108 to secure the pleated prefilter 22 in place on the filter assembly 14.

The illustrated WTS 10 may also include a highly accurate volumetric flow meter (not shown) to measure flow rate through the WTS 10. The flow meter tracks the volume of fluid through the systems and is not susceptible to some of the inaccuracies inherent in meters that estimate flow rate based on WTS “on” time. The WTS 10 may also track the amount of time that has passed since the filter was installed to provide a second mechanism for tracking filter life. This second mechanism is not used to estimate the volume of fluid that has passed through the system, but rather to track time-based rather than use-based filter life. In the illustrated embodiment, the flow meter includes a flow turbine with electronic sensing (not shown) and a microprocessor. The flow turbine spins in direct proportion to the volume of water passing through the system. The electronic sensing device (not shown) senses rotation of the flow turbine, for example, by generating an electronic pulse for each rotation of the turbine. For example, the flow turbine may include magnetic material and the electronic sensing device may include a sensor capable of generating signals in response to the magnetic material in the rotation flow turbine. The WTS 10 includes a control system incorporated into electronics module 400 that is capable of receiving signals from the electronic sensing device and calculating water volume based on the signals. The WTS is programmed with a preset volume and/or time depending on the filter used. For example, in one application the WTS may include a filter rated for 1,000 gallons of flow or one year of installed time, whichever comes first. The WTS may include one or more indicators to notify the user when a filter needs to be replaced. For example, the WTS 10 may include light-emitting diodes (“LEDs”) that are illuminated to provide a visual indication when a filter needs to be replaced. The control system can also be programmed to provide a visual indication when the filter status is acceptable. For example, the control system may provide a flashing light when the treated water is being dispensed while the filter status is acceptable. The flashing light may change color to show that a filter needs to be replaced. For example, a green flashing light may be presented when the filter status is acceptable and a red flashing light may be presented when a filter needs to be replaced. In addition or in the alternative, the WTS 10 can incorporate a noise generator, such as a speaker, to provide an audible indication when a filter needs to be replaced. If desired, the control system can be programmed to prevent water from flowing through the WTS 10 when a filter needs to be replaced. The WTS 10 can be programmed to provide a warning when a filter is nearing the end of its operating life. For example, the WTS 10 may illuminate a warning light when a filter is at approximately 90 percent of its life. The user may use this advance warning to obtain a new filter before the life of the existing filter expires.

As an alternative, the filter assembly 14 (or an individual filter) may include one or more RFID smart chips (not shown) that retain all preset and usage information for the filter. An RFID smart chip can convey this information to the WTS 10 so that the WTS can convey the appropriate signals to the user regarding filter status. The RFID smart chip helps to protect the user from utilizing a filter beyond its useful life because it will have accurate information regarding the filter even if the filter is accidentally reinstalled after its useful life has expired. For example, an RFID smart chip can be programmed with the capacity of the filter, such as 600 gallon or one year whichever. When installed in the WTS 10, this information can be passed to the control system so that the WTS 10 can provide the appropriate information to the user. An RFID smart chip may also maintain a record of filter use and installed time in nonvolatile memory. Usage information can be collected by the WTS 10 and sent to an RFID smart chip for storage in memory. The WTS 10 may obtain usage information from an RFID smart chip when appropriate to allow accurate filter status information to be conveyed to the user. The RFID smart chip may also include a password that allows the WTS 10 to recognize whether or not the filter is “genuine.” The one or more RFID smart chips and relating electronic controls may be manufactured in accordance with the teaching of U.S. Pat. No. 6,673,250 to Kuennen et al, which is incorporated herein by reference in its entirety.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A water treatment system comprising:
a prefilter;
a carbon block filter; and
a microbiological interception filter that operate in combination to treat a fluid stream, such as water.

2. The water treatment system of claim 1 wherein said prefilter is a multi-layer nonwoven prefilter.

3. The water treatment system of claim 1 wherein said prefilter is a pleated fabric prefilter.

4. The water treatment system of claim 3 including two prefilters, one of said prefilters being a multi-layer nonwoven prefilter and the other of said prefilters being a pleated fabric prefilter.

5. The water treatment system of claim 4 wherein said two prefilters, said carbon block filter and said microbiological interception filter are arranged in a coaxial configuration.

6. The water treatment system of claim 5 wherein said microbiological interception filter is located at the center of said coaxial configuration, said carbon block filter surrounding said microbiological interception filter, said nonwoven prefilter wrapped about said carbon block filter, and said pleated fabric filter disposed about said nonwoven prefilter.

7. The water treatment system of claim 6 including a water inlet and a water outlet, said water inlet directing water through said filters such that said water flows radially inwardly through each successive filter.

8. The water treatment system of claim 7 wherein said microbiological interception filter, said carbon block filter and said prefilters are combined into a single filter assembly that facilitates removal and replacement of all of said filters simultaneously.

9. The water treatment system of claim 1 wherein said microbiological interception filter includes a microporous structure and a microbiological interception enhancing agent formed on said microporous structure.

10. The water treatment system of claim 1 wherein said microbiological interception filter includes activated carbon particles having a mean particle diameter between about 60 microns and about 80 microns.

11. A water treatment system comprising:
a housing defining a filter chamber; and
a filter assembly removably connected within said filter chamber, said filter assembly including a prefilter, a carbon block filter and a microbiological interception filter.

12. The water treatment system of claim 11 wherein said microbiological interception filter includes a microporous structure including plurality of activated carbon particles joined by a binder, and a microbiological interception agent formed on said microporous structure, said activated carbon particles configured to maintain a substantially constant over the useful life of said microbiological interception filter, wherein said activated carbon particles have a mean particle diameter of between about 60 microns and about 80 microns, and in which the +140 micron diameter mesh particles and the −500 micron diameter mesh particles are each less than about 10% of the particle size distribution.

13. The water treatment system of claim 12 wherein said mean particle diameter of said activated carbon particles is about 65 microns to 75 microns, and in which the +140 micron diameter mesh particles and the −500 micron diameter mesh particles are each less than about 8% of the particle size distribution.

14. The water treatment system of claim 13 wherein said prefilter, said carbon block filter and said microbiological interception filter are arranged coaxially.

15. The water treatment system of claim 14 wherein said prefilter includes a nonwoven prefilter and a pleated prefilter.

16. The water treatment system of claim 15 including a water inlet and a water outlet, said water inlet directing water through said filters such that said water flows radially inwardly through each successive filter.

17. The water treatment system of claim 15 wherein said microbiological interception filter is located at the center of said coaxial configuration, said carbon block filter surrounding said microbiological interception filter, said nonwoven prefilter wrapped about said carbon block filter, and said pleated fabric filter disposed about said nonwoven prefilter.

18. The water treatment system of claim 17 including a volumetric flow meter including a flow turbine that spins in direct proportion to the volume of water passing through the system, and an electronic sensing device connected to said flow turbine.

19. The water treatment system of claim 18 wherein one or more of said microbiological interception filter, said carbon block filter, said nonwoven prefilter and said pleated fabric filter includes an RFID chip, said chip programmed with information unique to that said one or more filters.

20. A water treatment system comprising:
a housing defining a sealed filter chamber;
a filter assembly removably connected within said filter chamber, said filter assembly including a prefilter, a carbon block filter and a microbiological interception filter, wherein said microbiological interception filter includes a microporous structure including plurality of activated carbon particles joined by a binder, and a microbiological interception agent formed on said microporous structure, said activated carbon particles configured to maintain a substantially constant over the useful life of said microbiological interception filter, wherein said activated carbon particles have a mean particle diameter of between about 60 microns and about 80 microns, and in which the +140 micron diameter mesh particles and the −500 micron diameter mesh particles are each less than about 10% of the particle size distribution;
a flow meter capable of sensing the volume of water that has passed through the water treatment system;
a timer capable of recording the amount of time that has passed since said microbiological interception filter was installed; and
a control system programmed with a preset volume and a preset time at which to signal a user that the microbiological filter needs to be replaced.
